(19) United States
(12) Patent Application Publication
(10) Pub. No.: US 2025/0168851 A1
(43) Pub. Date: May 22, 2025

(54) METHODS AND APPARATUSES FOR NON-CODEBOOK BASED PUSCH TRANSMISSION

(71) Applicant: Lenovo (Beijing) Limited, Beijing (CN)

(72) Inventors: Wei Ling, Beijing (CN); Yi Zhang, Beijing (CN); Chenxi Zhu, Beijing (CN); Bingchao Liu, Beijing (CN); Lingling Xiao, Beijing (CN)

(73) Assignee: Lenovo (Beijing) Limited, Beijing (CN)

(21) Appl. No.: 18/839,314

(22) PCT Filed: Apr. 25, 2022
(86) PCT No.: PCT/CN2022/088933

§ 371 Date: Aug. 16, 2024

(51) Int. Cl. H04W 72/21; H04L 5/00

(52) U.S. Cl. CPC H04W 72/21; H04L 5/0048

(57) ABSTRACT

The present application relates to methods and apparatuses for non-codebook based physical uplink shared channel (PUSCH) transmission. One embodiment of the present disclosure provides a user equipment (UE), which includes: a transceiver; and a processor coupled with the transceiver and configured to: receive, with the transceiver, configuration information, wherein the configuration information indicates that a first sounding reference signal (SRS) resource set and a second SRS resource set are configured for a non-codebook based PUSCH transmission; and transmit, with the transceiver, the PUSCH transmission according to SRS resource(s) in at least one SRS resource set of the first SRS resource set and the second SRS resource set, wherein at least one phase tracking reference signal (PT-RS) of the PUSCH transmission is transmitted with at least one PT-RS port based on the configuration information.

### TECHNICAL FIELD

The present disclosure relates to wireless communication technology, and more particularly, relates to methods and apparatuses for non-codebook based physical uplink shared channel (PUSCH) transmission.

### BACKGROUND OF THE INVENTION

In single downlink control information (S-DCI) based multiple transmit-receive point (M-TRP) multiple panel simultaneous uplink (UL) transmission, different layers of a PUSCH transmission may be transmitted from two panels. Therefore, the phase tracking reference signal (PT-RS) ports of layers from different UL panels should be different. However, the PT-RS ports of a non-codebook based PUSCH transmission is determined by the scheduled sounding reference signal (SRS) resource(s), and it is possible that the scheduled SRS resources are associated with two panels but configured with the same PT-RS port index if there is not limitation on the scheduled SRS resources for the non-codebook based PUSCH transmission.

Therefore, it is advantageous to provide solutions for non-codebook based PUSCH transmission to solve the above issue.

### SUMMARY

One embodiment of the present disclosure provides a user equipment (UE), which includes: a transceiver; and a processor coupled with the transceiver and configured to: receive, with the transceiver, configuration information, wherein the configuration information indicates that a first SRS resource set and a second SRS resource set are configured for a non-codebook based PUSCH transmission; and transmit, with the transceiver, the PUSCH transmission according to SRS resource(s) in at least one SRS resource set of the first SRS resource set and the second SRS resource set, wherein at least one PT-RS of the PUSCH transmission is transmitted with at least one PT-RS port based on the configuration information.

In some embodiments, in the case that the UE has reported a UE capability of supporting full-coherent uplink transmission for both the first SRS resource set and the second SRS resource set, or a maximum number of PT-RS ports for each SRS resource set is configured as one, all SRS resources in the first SRS resource set are configured with a first PT-RS port and all SRS resources in the second SRS resource set are configured with a second PT-RS port.

In some embodiments, in the case that the PUSCH transmission is associated with the second SRS resource set, the processor is configured to transmit a PT-RS of the PUSCH transmission with the first PT-RS port.

In some embodiments, in the case that the PUSCH transmission is associated with the second SRS resource set, the processor is configured to transmit a PT-RS of the PUSCH transmission with the second PT-RS port, and the processor is further configured to determine a demodulation reference signal (DM-RS) port associated with the second PT-RS port based on a PTRS-DMRS association indicator and a PTRS-DMRS association table for the first PT-RS port.

In some embodiments, in the case that the UE has reported a UE capability of supporting full-coherent uplink transmission for both the first SRS resource set and the second SRS resource set, or a maximum number of PT-RS ports for each SRS resource set is configured as one, all SRS resources in the first SRS resource set and all SRS resources in the second SRS resource set are configured with a first PT-RS port.

In some embodiments, in the case that a first set of layers of the PUSCH transmission is associated with the first SRS resource set and a second set of layers of the PUSCH transmission is associated with the second SRS resource set, the processor is configured to transmit a first PT-RS associated with the first set of layers of the PUSCH transmission with the first PT-RS port, and transmit a second PT-RS associated with the second set of layers of the PUSCH transmission with the second PT-RS port.

In some embodiments, in the case that a total number of PT-RS ports configured for all SRS resources in each of the first SRS resource set and the second SRS resource set is 2, wherein the configured PT-RS ports include a first PT-RS port and a second PT-RS port, and a first set of layers of the PUSCH transmission is associated with the first SRS resource set and a second set of layers of the PUSCH transmission is associated with the second SRS resource set, the processor is configured to: transmit the first set of layers of the PUSCH transmission according to at least one SRS resource which is configured with the first PT-RS port in the first SRS resource set, wherein a first PT-RS associated with the first set of layers of the PUSCH transmission is transmitted with the first PT-RS port, and transmit the second set of layers of the PUSCH transmission according to at least one SRS resource which is configured with the second PT-RS port in the second SRS resource set, wherein a second PT-RS associated with the second set of layers of the PUSCH transmission is transmitted with the second PT-RS port, or transmit the first set of layers of the PUSCH transmission according to at least one SRS resource which is configured with the second PT-RS port in the first SRS resource set, wherein a first PT-RS associated with the first set of layers of the PUSCH transmission is transmitted with the second PT-RS port, and transmit the second set of layers of the PUSCH transmission according to at least one SRS resource which is configured with the first PT-RS port in the second SRS resource set, wherein a second PT-RS associated with the second set of layers of the PUSCH transmission is transmitted with the first PT-RS port.

Another embodiment of the present disclosure provides a base station (BS), which includes: a transceiver; and a processor coupled with the transceiver and configured to: transmit, with the transceiver, configuration information, wherein the configuration information indicates that a first SRS resource set and a second SRS resource set are configured for a non-codebook based PUSCH transmission; and receive, with the transceiver, the PUSCH transmission according to SRS resource(s) in at least one SRS resource set of the first SRS resource set and the second SRS resource set, wherein at least one PT-RS of the PUSCH transmission is received with at least one PT-RS port based on the configuration information.

In some embodiments, all SRS resources in the first SRS resource set are configured with a first PT-RS port and all SRS resources in the second SRS resource set are configured with a second PT-RS port.

In some embodiments, in the case that the PUSCH transmission is associated with the second SRS resource set, the processor is configured to receive a PT-RS of the PUSCH transmission with the first PT-RS port.

In some embodiments, in the case that the PUSCH transmission is associated with the second SRS resource set, the processor is configured to receive a PT-RS of the PUSCH transmission with the second PT-RS port, and the processor is further configured to determine a DM-RS port associated with the second PT-RS port based on a PTRS-DMRS association indicator and a PTRS-DMRS association table for the first PT-RS port.

In some embodiments, all SRS resources in the first SRS resource set and all SRS resources in the second SRS resource set are configured with a first PT-RS port.

In some embodiments, in the case that a first set of layers of the PUSCH transmission is associated with the first SRS resource set and a second set of layers of the PUSCH transmission is associated with the second SRS resource set, the processor is configured to receive a first PT-RS associated with the first set of layers of the PUSCH transmission with the first PT-RS port, and receive a second PT-RS associated with the second set of layers of the PUSCH transmission with the second PT-RS port.

In some embodiments, in the case that a total number of PT-RS ports configured for all SRS resources in each of the first SRS resource set and the second SRS resource set is 2, wherein the configured PT-RS ports include a first PT-RS port and a second PT-RS port, and a first set of layers of the PUSCH transmission is associated with the first SRS resource set and a second set of layers of the PUSCH transmission is associated with the second SRS resource set, the processor is configured to: receive the first set of layers of the PUSCH transmission according to at least one SRS resource which is configured with the first PT-RS port in the first SRS resource set, wherein a first PT-RS associated with the first set of layers of the PUSCH transmission is received with the first PT-RS port, and receive the second set of layers of the PUSCH transmission according to at least one SRS resource which is configured with the second PT-RS port in the second SRS resource set, wherein a second PT-RS associated with the second set of layers of the PUSCH transmission is received with the second PT-RS port, or receive the first set of layers of the PUSCH transmission according to at least one SRS resource which is configured with the second PT-RS port in the first SRS resource set, wherein a first PT-RS associated with the first set of layers of the PUSCH transmission is received with the second PT-RS port, and receive the second set of layers of the PUSCH transmission according to at least one SRS resource which is configured with the first PT-RS port in the second SRS resource set, wherein a second PT-RS associated with the second set of layers of the PUSCH transmission is received with the first PT-RS port.

Yet another embodiment of the present disclosure provides a method performed by a UE, which includes: receiving configuration information, wherein the configuration information indicates that a first SRS resource set and a second SRS resource set are configured for a non-codebook based PUSCH transmission; and transmitting the PUSCH transmission according to SRS resource(s) in at least one SRS resource set of the first SRS resource set and the second SRS resource set, wherein at least one PT-RS of the PUSCH transmission is transmitted with at least one PT-RS port based on the configuration information.

Still another embodiment of the present disclosure provides a method performed by a BS, which includes: transmitting configuration information, wherein the configuration information indicates that a first SRS resource set and a second SRS resource set are configured for a non-codebook based PUSCH transmission; and receiving the PUSCH transmission according to SRS resource(s) in at least one SRS resource set of the first SRS resource set and the second SRS resource set, wherein at least one PT-RS of the PUSCH transmission is received with at least one PT-RS port based on the configuration information.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system according to some embodiments of the present disclosure.

FIG. 2 illustrates a flowchart of an exemplary method for non-codebook based PUSCH transmission according to some embodiments of the present disclosure.

FIG. 3 illustrates a flowchart of another exemplary method for non-codebook based PUSCH transmission according to some embodiments of the present disclosure.

FIG. 4 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G new radio (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

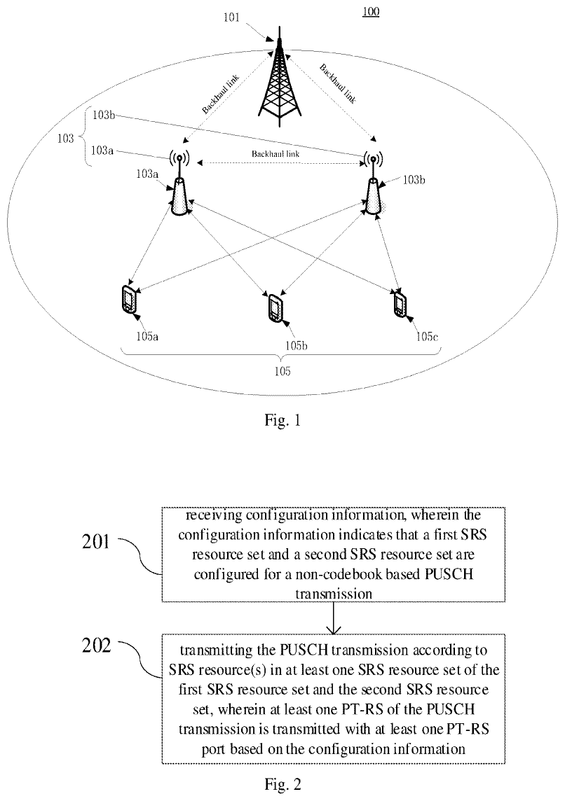

FIG. 1 is a schematic diagram illustrating an exemplary wireless communication system 100 according to some embodiments of the present application.

Referring to FIG. 1, the wireless communication system 100 can include a BS 101. TRPs 103 (e.g., TRP 103a and TRP 103b), and UEs 105 (e.g., UE 105a, UE 105b, and UE 105c). Although only one BS 101, two TRPs 103 and three UEs 105 are shown for simplicity, it should be noted that the wireless communication system 100 may include more or less communication device(s), apparatus, or node(s) in accordance with some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The UE(s) 105 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 105 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 105 may include wearable devices, such as smart watches, fitness bands, optical head-mounted displays, or the like. Moreover, the UE(s) 105 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present application, the BS 101 may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. The BS 101 is generally part of a radio access network that may include a controller communicably coupled to the BS 101.

The TRPs 103, for example, the TRP 103a and the TRP 103b, can communicate with the BS 101 via, for example, a backhaul link. Each of TRPs 103 can serve some or all of the UEs 105. As shown in FIG. 1, the TRP 103a can serve some mobile stations (which include the UE 105a, the UE 105b, and the UE 105c) within a serving area or region (e.g., a cell or a cell sector). The TRP 103b can serve some mobile stations (which include the UE 105a, the UE 105b, and the UE 105c) within a serving area or region (e.g., a cell or a cell sector). In some other embodiments, the TRP 103a and the TRP 103b can serve different UEs. The TRP 103a and the TRP 103b can communicate with each other via, for example, a backhaul link.

In order to improve the uplink throughput and uplink reliability, simultaneous uplink transmissions with multiple panels to multiple TRPs, for example, up to 2 TRPs and up to 2 panels, are studied.

A PUSCH transmission from a UE may include transmission of at least one PT-RS on at least one PT-RS port configured to the UE. The maximum number of PT-RS ports is configured by a higher layer parameter, e.g., maxNrofPorts as specified in 3GPP standard documents, in a configuration for UL PT-RS, e.g., PTRS-UplinkConfig as specified in 3GPP standard documents. The UE is not expected to be configured with a larger number of UL PT-RS ports than it has reported need for. For example, if the UE has reported that the UE needs one PT-RS port, the UE may be configured with one PT-RS port, and will not be configured with two PT-RS ports.

If the UE has reported a capability of supporting full-coherent UL transmission for a panel (or for an SRS resource set), the UE shall expect the number of UL PT-RS ports to be configured for the panel (or for the SRS resource set) as one when UL PT-RS is configured. For example, in the case that the UE has reported a capability of supporting full-coherent UL transmission for either the first panel or the second panel, the UE may be configured with one UL PT-RS ports for either the first panel or the second panel.

For a non-codebook based UL transmission, the actual number of UL PT-RS port(s) for transmitting PT-RS(s) is determined based on a signal resource indicator (SRI) in downlink control information (DCI) scheduling or activating the UL transmission (e.g., DCI format 0_1 or DCI format 0_2 as specified in 3GPP standard documents), or a higher layer parameter (e.g., sri-ResourceIndicator as specified in 3GPP standard documents) in an uplink grant (e.g. rrc-ConfiguredUplinkGrant as specified in 3GPP standard documents) associated with the UL transmission. When two SRS resource sets are configured for a non-codebook based UL transmission, for example, when two SRS resource sets are configured in srs-ResourceSetToAddModList or srs-ResourceSetToAddModListDCI-0-2 with a higher layer parameter “usage” in SRS-ResourceSet being set to “noncodebook,” the actual number of UL PT-RS port(s) for transmitting PT-RS(s) corresponding to each SRS resource set is determined based on the SRI(s) corresponding to the associated SRS resource set or the higher layer parameter (e.g., sri-ResourceIndicator or sri-ResourceIndicator2 as specified in 3GPP standard documents) corresponding to the associated SRS resource set in the uplink grant (e.g., rrc-ConfiguredUplinkGrant as specified in 3GPP standard documents).

A UE may be configured with a PT-RS port index for each configured SRS resource by a higher layer parameter (e.g., ptrs-PortIndex as specified in 3GPP standard documents) configured by a configuration for SRS (e.g., SRS-Config as specified in 3GPP standard documents) if the UE is configured with a higher layer parameter (e.g., phaseTrackingRS as specified in 3GPP standard documents) in a configuration for UL DM-RS (e.g., DMRS-UplinkConfig as specified in 3GPP standard documents). If different SRIs are associated with the same PT-RS port index, the corresponding UL DM-RS ports are associated to the same UL PT-RS port corresponding to the PT-RS port index.

The present disclosure proposes some solutions for configuring PT-RS port(s) for SRS resources in two SRS resource sets and solutions for transmitting PT-RS(s) in S-DCI based M-TRP (SDM) PUSCH transmission, which refers to a PUSCH transmission associated with multiple TRPs scheduled by a single DCI with multiple beams simultaneously.

In the present disclosure, a UE may perform multiple panel simultaneous UL transmission supported in S-DCI based M-TRP PUSCH transmission. Two SRS resource sets are configured for a non-codebook based PUSCH transmission, where a first SRS resource set of the two SRS resource sets is the SRS resource set with a lower index and may be associated with a first TRP, and a second SRS resource set of the two SRS resource sets is the SRS resource set with a higher index and may be associated with a second TRP.

In some embodiments, the UE may report a UE capability of supporting full-coherent uplink transmission for both panels of the UE, i.e., for both the first SRS resource set and the second SRS resource set, and thus the UE may expect that the number of PT-RS ports to be configured is one if the PT-RS port is configured. Or, the maximum number of PT-RS ports for each panel (i.e., for each SRS resource set), which may be configured by a higher layer parameter (e.g., maxNrofPorts as specified in 3GPP standard documents), is configured as one. Under such conditions, the present disclosure proposes some solutions for determining PT-RS port(s) for transmitting PT-RS(s) of a non-codebook based PUSCH transmission.

### Solution 1:

In solution 1, all the SRS resources in the first SRS resource set are configured with a first PT-RS port (e.g., PT-RS port 0), and all the SRS resources in the second SRS resource set are configured with a second PT-RS port (e.g., PT-RS port 0). Solution 1 may include solution 1-1 and solution 1-2.

### Solution 1-1:

In some embodiments of the present disclosure, a PUSCH transmission may include multiple layers, and these layers may include a first set of layers associated with the first SRS resource set (e.g., the first set of layers is to be transmitted to the first TRP) and a second set of layers associated with the second SRS resource set (e.g., the second set of layers is to be transmitted to the second TRP). That is, the PUSCH transmission is transmitted with two beams or two panels simultaneously. Two PT-RS ports for transmitting a first PT-RS associated with the first set of layers and a second PT-RS associated with the second set of layers respectively may be determined as follows:

The first PT-RS port, e.g., PT-RS port 0, which is associated with the first SRS resource set, is used for transmitting the first PT-RS associated with the first set of layers of the PUSCH transmission. A first DM-RS port associated with the first PT-RS port may be determined based on a PTRS-DMRS association indicator, which may be in a PTRS-DMRS association field in the DCI scheduling or activating the PUSCH transmission (e.g., in the case that the PUSCH transmission is a dynamic grant (DG) PUSCH transmission or Type 2 configured grant (CG) PUSCH transmission) or in a radio resource control (RRC) configuration associated with the PUSCH transmission (e.g., in the case that the PUSCH transmission is a Type 1 CG PUSCH transmission), and a PTRS-DMRS association table.

The second PT-RS port, e.g., PT-RS port 1, which is associated with the second SRS resource set, is used for transmitting the second PT-RS associated with the second set of layers of the PUSCH transmission. A second DM-RS port associated with the second PT-RS port may also be determined based on the PTRS-DMRS association indicator, which may be in a PTRS-DMRS association field in the DCI scheduling or activating the PUSCH transmission (e.g., in the case that the PUSCH transmission is a DG PUSCH transmission or Type 2 CG PUSCH transmission) or in an RRC configuration associated with the PUSCH transmission (e.g., in the case that the PUSCH transmission is a Type 1 CG PUSCH transmission), and a PTRS-DMRS association table.

For example, the first and second DM-RS ports associated with the first and second PT-RS ports respectively may be determined based on the following Table 1:

TABLE 1
PTRS-DMRS association for two PT-RS ports

| Value of | | Value of | |
|---|---|---|---|
| MSB of | DM-RS port | LSB of | DM-RS port |
| PTRS-DMRS | associated | PTRS-DMRS | associated |
| association | with PT-RS | association | with PT-RS |
| indicator | port 0 | indicator | port 1 |
| 0 | 1^{st} DM-RS port | 0 | 1^{st} DM-RS port |
| | which shares PT- | | which shares PT- |
| | RS port 0 | | RS port 1 |
| 1 | 2^{nd} DM-RS port | 1 | 2^{nd} DM-RS port |
| | which shares PT- | | which shares PT- |
| | RS port 0 | | RS port 1 |

a): The PTRS-DMRS association indicator is “00” (i.e., the value of most significant bit (MSB) is 0 and the value of least significant bit (LSB) is 0). According to Table 1, the 1st DM-RS port which shares PT-RS port 0 is determined as the first DM-RS port associated with the first PT-RS port, and the 1^{st} DM-RS port which shares PT-RS port 1 is determined as the second DM-RS port associated with the second PT-RS port.
b): The PTRS-DMRS association indicator is “01” (i.e., the value of MSB is 0 and the value of LSB is 1).
According to Table 1, the 1st DM-RS port which shares PT-RS port 0 is determined as the first DM-RS port associated with the first PT-RS port, and the 2nd DM-RS port which shares PT-RS port 1 is determined as the second DM-RS port associated with the second PT-RS port.
c): The PTRS-DMRS association indicator is “10” (i.e., the value of MSB is 1 and the value of LSB is 0).
According to Table 1, the 2nd DM-RS port which shares PT-RS port 0 is determined as the first DM-RS port associated with the first PT-RS port, and the 1st DM-RS port which shares PT-RS port 1 is determined as the second DM-RS port associated with the second PT-RS port.
d): The PTRS-DMRS association indicator is “11” (i.e., the value of MSB is 1 and the value of LSB is 1).
According to Table 1, the 2^{nd} DM-RS port which shares PT-RS port 0 is determined as the first DM-RS port associated with the first PT-RS port, and the 2^{nd} DM-RS port which shares PT-RS port 1 is determined as the second DM-RS port associated with the second PT-RS port.

### Solution 1-2:

In some embodiments of the present disclosure, a PUSCH transmission may be transmitted with one beam which is associated with one SRS resource set of the two SRS resource sets. Then, only one PT-RS port for transmitting a PT-RS of the PUSCH transmission may be determined as follows.

In the case that the PUSCH transmission is associated with the first SRS resource set, the first PT-RS port, e.g., PT-RS port 0, which is associated with the first SRS resource set is determined for transmitting the PT-RS of the PUSCH transmission. A DM-RS port associated with the first PT-RS port may be determined based on the PTRS-DMRS association indicator, which may be in a PTRS-DMRS association field in the DCI scheduling or activating the PUSCH transmission (e.g., in the case that the PUSCH transmission is a DG PUSCH transmission or Type 2 CG PUSCH transmission) or in an RRC configuration associated with the PUSCH transmission (e.g., in the case that the PUSCH transmission is a Type 1 CG PUSCH transmission), and a PTRS-DMRS association table.

For example, the DM-RS port associated with the first PT-RS port may be determined based on the following Table 2:

TABLE 2
PTRS-DMRS association for PT-RS port 0

| Value | DM-RS port |
|---|---|
| 0 | 1^{st} scheduled DM-RS port |
| 1 | 2^{nd} scheduled DM-RS port |
| 2 | 3^{rd} scheduled DM-RS port |
| 3 | 4^{th} scheduled DM-RS port |

According to Table 2, in the case that the value of the PTRS-DMRS association indicator is 0 (e.g., “00”), the DM-RS port is determined to be the 1^{st} scheduled DM-RS port; in the case that the value of the PTRS-DMRS association indicator is 1 (e.g., “01”), the DM-RS port is determined to be the 2^{nd} scheduled DM-RS port; in the case that the value of the PTRS-DMRS association indicator is 2 (e.g., “10”), the DM-RS port is determined to be the 3^{rd} scheduled DM-RS port; and in the case that the value of the PTRS-DMRS association indicator is 3 (e.g., “11”), the DM-RS port is determined to be the 4th scheduled DM-RS port.

In the case that the PUSCH transmission is associated with the second SRS resource set, according to an embodiment of the present disclosure, although the second SRS resource set is associated with the second PT-RS port, e.g., PT-RS port 1, the UE may still use the first PT-RS port, e.g., PT-RS port 0, for transmitting the PT-RS of the PUSCH transmission. Correspondingly, a DM-RS port associated with the first PT-RS port may be determined based on the PTRS-DMRS association indicator, which may be in a PTRS-DMRS association field in the DCI scheduling or activating the PUSCH transmission (e.g., in the case that the PUSCH transmission is a DG PUSCH transmission or Type 2 CG PUSCH transmission) or in an RRC configuration associated with the PUSCH transmission (e.g., in the case that the PUSCH transmission is a Type 1 CG PUSCH transmission), and a PTRS-DMRS association table (e.g., the above Table 2).

Alternatively, according to another embodiment of the present disclosure, the UE may use the second PT-RS port, e.g., PT-RS port 1, for transmitting the PT-RS of the PUSCH transmission in the case that the PUSCH transmission is associated with the second SRS resource set. A DM-RS port associated with the second PT-RS port may be determined based on the PTRS-DMRS association indicator, which may be in a PTRS-DMRS association field in the DCI scheduling or activating the PUSCH transmission (e.g., in the case that the PUSCH transmission is a DG PUSCH transmission or Type 2 CG PUSCH transmission) or in an RRC configuration associated with the PUSCH transmission (e.g., in the case that the PUSCH transmission is a Type 1 CG PUSCH transmission), and a PTRS-DMRS association table. In an embodiment, in the case that only one PTRS-DMRS association table for the first PT-RS port (e.g., the above Table 2) is provided with no PTRS-DMRS association table for the second PT-RS port, the PTRS-DMRS association table for the first PT-RS port may be used to determine the DM-RS port associated with the second PT-RS port.

### Solution 2:

In solution 2, all the SRS resources in the first SRS resource set and all the SRS resources in the second SRS resource set are configured with the first PT-RS port (e.g., PT-RS port 0).

In some embodiments of the present disclosure, a PUSCH transmission may include multiple layers, and these layers may include a first set of layers associated with the first SRS resource set (e.g., the first set of layers is to be transmitted to the first TRP) and a second set of layers associated with the second SRS resource set (e.g., the second set of layers is to be transmitted to the second TRP). That is, the PUSCH transmission is transmitted with two beams or two panels simultaneously. Two PT-RS ports are needed to be determined for transmitting a first PT-RS associated with the first set of layers and a second PT-RS associated with the second set of layers respectively although the two SRS resource sets are associated with the same PT-RS port.

For example, the two PT-RS ports may be determined as follows:

The first PT-RS port, e.g., PT-RS port 0, is used for transmitting the first PT-RS associated with the first set of layers of the PUSCH transmission. A first DM-RS port associated with the first PT-RS port may be determined based on a PTRS-DMRS association indicator, which may be in a PTRS-DMRS association field in the DCI scheduling or activating the PUSCH transmission (e.g., in the case that the PUSCH transmission is a DG PUSCH transmission or Type 2 CG PUSCH transmission) or in an RRC configuration associated with the PUSCH transmission (e.g., in the case that the PUSCH transmission is a Type 1 CG PUSCH transmission), and a PTRS-DMRS association table (e.g., the above Table 1).

The second PT-RS port, e.g., PT-RS port 1, is used for transmitting the second PT-RS associated with the second set of layers of the PUSCH transmission. A second DM-RS port associated with the second PT-RS port may also be determined based on the PTRS-DMRS association indicator, which may be in a PTRS-DMRS association field in the DCI scheduling or activating the PUSCH transmission (e.g., in the case that the PUSCH transmission is a DG PUSCH transmission or Type 2 CG PUSCH transmission) or in an RRC configuration associated with the PUSCH transmission (e.g., in the case that the PUSCH transmission is a Type 1 CG PUSCH transmission), and a PTRS-DMRS association table (e.g., the above Table 1).

In some embodiments of the present disclosure, a PUSCH transmission may be transmitted with one beam which is associated with one SRS resource set of the two SRS resource sets. Then, the first PT-RS port, e.g., PT-RS port 0, is used for transmitting a PT-RS of the PUSCH transmission. A DM-RS port associated with the first PT-RS port may be determined based on the PTRS-DMRS association indicator, which may be in a PTRS-DMRS association field in the DCI scheduling or activating the PUSCH transmission (e.g., in the case that the PUSCH transmission is a DG PUSCH transmission or Type 2 CG PUSCH transmission) or in an RRC configuration associated with the PUSCH transmission (e.g., in the case that the PUSCH transmission is a Type 1 CG PUSCH transmission), and a PTRS-DMRS association table (e.g., the above Table 2).

According to some embodiments of the present disclosure, the total number of PT-RS ports configured for all SRS resources in each of the two SRS resource sets is 2. That is, two PT-RS ports are configured for the two SRS resource sets.

Under the above configuration, in order to support an SDM PUSCH transmission, where a first set of layers of the PUSCH transmission is associated with the first SRS resources set and a second set of layers of the PUSCH transmission is associated with the second SRS resources set, i.e., the PUSCH transmission is transmitted with two beams or two panels simultaneously, SRS resources for the PUSCH transmission may be indicated by a BS with the following limitations:
1. Any two SRS resources from two SRS resource sets of the SRS resources for the PUSCH transmission are associated with different PT-RS port indexes (i.e., different PT-RS ports).
2. All SRS resources from the same SRS resource set of the SRS resources for the PUSCH transmission are associated with the same PT-RS port index (i.e., the same PT-RS port).

The SRS resources for the PUSCH transmission can be indicated from the BS by SRI field(s) in the DCI scheduling or activating the PUSCH transmission (e.g., in the case that the PUSCH transmission is a DG PUSCH transmission or Type 2 CG PUSCH transmission) or configured in an RRC configuration associated with the PUSCH transmission (e.g., in the case that the PUSCH transmission is a Type 1 CG PUSCH transmission).

For example, it is assumed that the first SRS resource set (e.g., SRS resource set 1) and the second SRS resource set (e.g., SRS resource set 2) are configured for a non-codebook based PUSCH transmission. SRS resource set 1 includes 4 SRS resources, which are SRS resource 0, SRS resource 1, SRS resource 2, and SRS resource 3, wherein SRS resource 0 and SRS resource 1 are configured with PT-RS port 0, and SRS resource 2 and SRS resource 3 are configured with PT-RS port 1. SRS resource set 2 includes 4 SRS resources, which are SRS resource 4, SRS resource 5, SRS resource 6, and SRS resource 7, wherein SRS resource 4 and SRS resource 5 are configured with PT-RS port 0, and SRS resource 6 and SRS resource 7 are configured with PT-RS port 1.

The following Table 3 illustrates the above configurations:

TABLE 3

| | |
|---|---|
| SRS resource set 1 | SRS resource set 2 |

| | associated | | associated |
|---|---|---|---|
| | PT-RS port | | PT-RS port |
| SRS resource | index | SRS resource | index |
| 0 | 0 | 4 | 0 |
| 1 | 0 | 5 | 0 |
| 2 | 1 | 6 | 1 |
| 3 | 1 | 7 | 1 |

In order to perform the non-codebook based PUSCH transmission with two beams simultaneously (i.e., SDM PUSCH transmission), a BS may indicate the SRS resources for the SDM PUSCH transmission based on the above rules. Table 4 below shows some alternatives in which two SRS resources from SRS resource set 1 and two SRS resources from SRS resource set 2 are selected:

TABLE 4

| | SRS resource set 1 | | SRS resource set 2 | |
|---|---|---|---|---|
| | | associated | | associated |
| | | PT-RS port | | PT-RS port |
| | SRS resource | index | SRS resource | index |
| Alt 1-1 | 0 | 0 | 6 | 1 |
| | 1 | 0 | 7 | 1 |
| Alt 1-2 | 2 | 1 | 4 | 0 |
| | 3 | 1 | 5 | 0 |

For example, for Alt 1-1, the UE may transmit the first set of layers of the PUSCH transmission associated with SRS resources set 1 according to SRS resource 0 and SRS resource 1 in SRS resource set 1, and transmit a first PT-RS associated with the first set of layers on PT-RS port 0. The UE may transmit the second set of layers of the PUSCH transmission associated with SRS resources set 2 according to SRS resource 6 and SRS resource 7 in SRS resource set 2, and transmit a second PT-RS associated with the second set of layers on PT-RS port 1.

For example, for Alt 1-2, the UE may transmit the first set of layers of the PUSCH transmission associated with SRS resources set 1 according to SRS resource 2 and SRS resource 3 in SRS resource set 1, and transmit a first PT-RS associated with the first set of layers on PT-RS port 1. The UE may transmit the second set of layers of the PUSCH transmission associated with SRS resources set 2 according to SRS resource 4 and SRS resource 5 in SRS resource set 2, and transmit a second PT-RS associated with the second set of layers on PT-RS port 0.

Table 5 below shows some alternatives in which two SRS resources from SRS resource set 1 and one SRS resource from SRS resource set 2 are selected:

TABLE 5

| | SRS resource set 1 | | SRS resource set 2 | |
|---|---|---|---|---|
| | | associated | | associated |
| | | PT-RS port | | PT-RS port |
| | SRS resource | index | SRS resource | index |
| Alt 2-1 | 0 | 0 | 6 | 1 |
| | 1 | 0 | | |
| Alt 2-2 | 0 | 0 | 7 | 1 |
| | 1 | 0 | | |
| Alt 2-3 | 2 | 1 | 4 | 0 |
| | 3 | 1 | | |
| Alt 2-4 | 2 | 1 | 5 | 0 |
| | 3 | 1 | | |

For example, for Alt 2-1, the UE may transmit the first set of layers of the PUSCH transmission associated with SRS resources set 1 according to SRS resource 0 and SRS resource 1 in SRS resource set 1, and transmit a first PT-RS associated with the first set of layers on PT-RS port 0. The UE may transmit the second set of layers of the PUSCH transmission associated with SRS resources set 2 according to SRS resource 6 in SRS resource set 2, and transmit a second PT-RS associated with the second set of layers on PT-RS port 1.

Table 6 below shows some alternatives in which one SRS resource from SRS resource set 1 and two SRS resources from SRS resource set 2 are selected:

TABLE 6

| | SRS resource set 1 | | SRS resource set 2 | |
|---|---|---|---|---|
| | | associated | | associated |
| | | PT-RS port | | PT-RS port |
| | SRS resource | index | SRS resource | index |
| Alt 3-1 | 0 | 0 | 6 | 1 |
| | | | 7 | 1 |
| Alt 3-2 | 1 | 0 | 6 | 1 |
| | | | 7 | 1 |
| Alt 3-3 | 2 | 1 | 4 | 0 |
| | | | 5 | 0 |
| Alt 3-4 | 3 | 1 | 4 | 0 |
| | | | 5 | 0 |

For example, for Alt 3-1, the UE may transmit the first set of layers of the PUSCH transmission associated with SRS resources set 1 according to SRS resource 0 in SRS resource set 1, and transmit a first PT-RS associated with the first set of layers on PT-RS port 0. The UE may transmit the second set of layers of the PUSCH transmission associated with SRS resources set 2 according to SRS resource 6 and SRS resource 7 in SRS resource set 2, and transmit a second PT-RS associated with the second set of layers on PT-RS port 1.

Table 7 below shows some alternatives in which one SRS resource from SRS resource set 1 and one SRS resource from SRS resource set 2 are selected:

TABLE 7

| | SRS resource set 1 | | SRS resource set 2 | |
|---|---|---|---|---|
| | | associated | | associated |
| | | PT-RS port | | PT-RS port |
| | SRS resource | index | SRS resource | index |
| Alt 4-1 | 0 | 0 | 6 | 1 |
| Alt 4-2 | 0 | 0 | 7 | 1 |
| Alt 4-3 | 1 | 0 | 6 | 1 |
| Alt 4-4 | 1 | 0 | 7 | 1 |
| Alt 4-5 | 2 | 1 | 4 | 0 |
| Alt 4-6 | 2 | 1 | 5 | 0 |
| Alt 4-7 | 3 | 1 | 4 | 0 |
| Alt 4-8 | 3 | 1 | 5 | 0 |

For example, for Alt 4-1, the UE may transmit the first set of layers of the PUSCH transmission associated with SRS resources set 1 according to SRS resource 0, and transmit a first PT-RS associated with the first set of layers on PT-RS port 0. The UE may transmit the second set of layers of the PUSCH transmission associated with SRS resources set 2 according to SRS resource 6 in SRS resource set 2, and transmit a second PT-RS associated with the second set of layers on PT-RS port 1.

FIG. 2 illustrates a flowchart of an exemplary method for non-codebook based PUSCH transmission according to some embodiments of the present disclosure. The method may be performed by a UE or other device or apparatus with similar functions.

In operation 201, the UE may receive configuration information, wherein the configuration information indicates that a first SRS resource set and a second SRS resource set are configured for a non-codebook based PUSCH transmission.

In operation 202, the UE may transmit the PUSCH transmission according to SRS resource(s) in at least one SRS resource set of the first SRS resource set and the second SRS resource set, wherein at least one PT-RS of the PUSCH transmission is transmitted with at least one PT-RS port based on the configuration information.

In some embodiments, in the case that the UE has reported a UE capability of supporting full-coherent uplink transmission for both the first SRS resource set and the second SRS resource set, or a maximum number of PT-RS ports for each SRS resource set is configured as one, all SRS resources in the first SRS resource set are configured with a first PT-RS port (e.g., PT-RS port 0) and all SRS resources in the second SRS resource set are configured with a second PT-RS port (e.g., PT-RS port 1).

In some embodiments, in the case that the PUSCH transmission is associated with the second SRS resource set, the UE may transmit a PT-RS of the PUSCH transmission with the first PT-RS port. For example, in solution 1-2, when the PUSCH transmission is associated with the second SRS resource set which is associated with the second PT-RS port, the UE may use the first PT-RS port, instead of the second PT-RS port, to transmit the PT-RS of the PUSCH transmission.

In some embodiments, in the case that the PUSCH transmission is associated with the second SRS resource set, the UE may transmit a PT-RS of the PUSCH transmission with the second PT-RS port, and determine a DM-RS port associated with the second PT-RS port based on a PTRS-DMRS association indicator and a PTRS-DMRS association table for the first PT-RS port. For example, in solution 1-2, when the PUSCH transmission is associated with the second SRS resource set which is associated with the second PT-RS port, the UE may use the second PT-RS port to transmit the PT-RS of the PUSCH transmission. The UE may determine the DM-RS port based on the abovementioned Table 2.

In some embodiments, in the case that the UE has reported a UE capability of supporting full-coherent uplink transmission for both the first SRS resource set and the second SRS resource set, or a maximum number of PT-RS ports for each SRS resource set is configured as one, all SRS resources in the first SRS resource set and all SRS resources in the second SRS resource set are configured with a first PT-RS port.

In some embodiments, in the case that a first set of layers of the PUSCH transmission is associated with the first SRS resource set and a second set of layers of the PUSCH transmission is associated with the second SRS resource set, the UE may transmit a first PT-RS associated with the first set of layers of the PUSCH transmission with the first PT-RS port, and transmit a second PT-RS associated with the second set of layers of the PUSCH transmission with the second PT-RS port.

In some embodiments, in the case that a total number of PT-RS ports configured for all SRS resources in each of the first SRS resource set and the second SRS resource set is 2, wherein the configured PT-RS ports include a first PT-RS port and a second PT-RS port, and a first set of layers of the PUSCH transmission is associated with the first SRS resource set and a second set of layers of the PUSCH transmission is associated with the second SRS resource set, the UE may: transmit the first set of layers of the PUSCH transmission according to at least one SRS resource which is configured with the first PT-RS port in the first SRS resource set, wherein a first PT-RS associated with the first set of layers of the PUSCH transmission is transmitted with the first PT-RS port, and transmit the second set of layers of the PUSCH transmission according to at least one SRS resource which is configured with the second PT-RS port in the second SRS resource set, wherein a second PT-RS associated with the second set of layers of the PUSCH transmission is transmitted with the second PT-RS port. For example, in the above Alt 2-1, the UE may transmit the first set of layers of the PUSCH transmission according to SRS resource 0 and SRS resource 1 in SRS resource set 1, transmit the first PT-RS on PT-RS port 0, transmit the second set of layers of the PUSCH transmission according to SRS resource 6 in SRS resource set 2, and transmit the second PT-RS on PT-RS port 1.

Alternatively, in the case that a total number of PT-RS ports configured for all SRS resources in each of the first SRS resource set and the second SRS resource set is 2, wherein the configured PT-RS ports include a first PT-RS port and a second PT-RS port, and a first set of layers of the PUSCH transmission is associated with the first SRS resource set and a second set of layers of the PUSCH transmission is associated with the second SRS resource set, the UE may: transmit the first set of layers of the PUSCH transmission according to at least one SRS resource which is configured with the second PT-RS port in the first SRS resource set, wherein a first PT-RS associated with the first set of layers of the PUSCH transmission is transmitted with the second PT-RS port, and transmit the second set of layers of the PUSCH transmission according to at least one SRS resource which is configured with the first PT-RS port in the second SRS resource set, wherein a second PT-RS associated with the second set of layers of the PUSCH transmission is transmitted with the first PT-RS port. For example, in the above Alt 2-3, the UE may transmit the first set of layers of the PUSCH transmission according to SRS resource 2 and SRS resource 3 in SRS resource set 1, transmit the first PT-RS on PT-RS port 1, transmit the second set of layers of the PUSCH transmission according to SRS resource 4 in SRS resource set 2, and transmit the second PT-RS on PT-RS port 0.

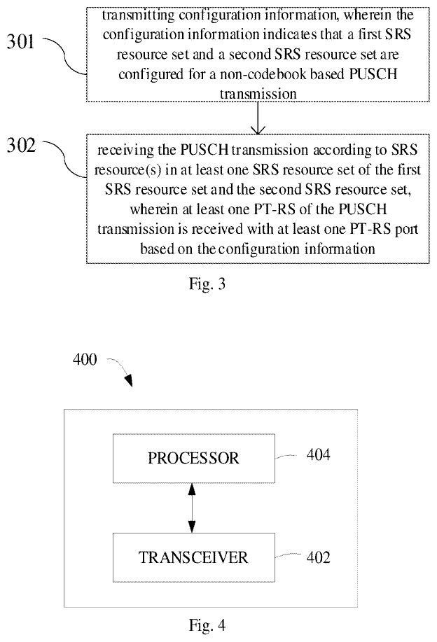

FIG. 3 illustrates a flowchart of another exemplary method for non-codebook based PUSCH transmission according to some embodiments of the present disclosure. The method may be performed by a BS or other device or apparatus with similar functions.

In operation 301, the BS may transmit configuration information, wherein the configuration information indicates that a first SRS resource set and a second SRS resource set are configured for a non-codebook based PUSCH transmission.

In operation 302, the BS may receive the PUSCH transmission according to SRS resource(s) in at least one SRS resource set of the first SRS resource set and the second SRS resource set, wherein at least one PT-RS of the PUSCH transmission is received with at least one PT-RS port based on the configuration information. The BS may perform operations corresponding to those performed by the UE to receive the PUSCH transmission and the PT-RS(s) of the PUSCH transmission.

FIG. 4 illustrates a simplified block diagram of an exemplary apparatus 400 according to some embodiments of the present disclosure.

As shown in FIG. 4, the apparatus 400 may include at least one processor 404 and at least one transceiver 402 coupled to the processor 404. The apparatus 400 may be or include at least part of a UE or a BS.

Although in this figure, elements such as the transceiver 402 and the processor 404 are described in the singular, the plural is contemplated unless a limitation to the singular is explicitly stated. In some embodiments of the present disclosure, the transceiver 402 may be divided into two devices, such as a receiving circuitry and a transmitting circuitry. In some embodiments of the present disclosure, the apparatus 400 may further include an input device, a memory, and/or other components.

In some embodiments of the present disclosure, the apparatus 400 may be a UE. The transceiver 402 and the processor 404 may interact with each other so as to perform the operations of the UE described with respect to any of FIGS. 1 and 2. In some embodiments of the present disclosure, the apparatus 400 may be a BS. The transceiver 402 and the processor 404 may interact with each other so as to perform the operations of the BS described with respect to any of FIGS. 1 and 3.

In some embodiments of the present disclosure, the apparatus 400 may further include at least one non-transitory computer-readable medium.

For example, in some embodiments of the present disclosure, the non-transitory computer-readable medium may have stored thereon computer-executable instructions to cause the processor 404 to implement any method performed by a UE as described above. For example, the computer-executable instructions, when executed, may cause the processor 404 interacting with the transceiver 402 to perform the operations of the UE described with respect to any of FIGS. 1 and 2.

In some embodiments of the present disclosure, the non-transitory computer-readable medium may have stored thereon computer-executable instructions to cause the processor 404 to implement any method performed by a BS as described above. For example, the computer-executable instructions, when executed, may cause the processor 404 interacting with the transceiver 402 to perform the operations of the BS described with respect to any of FIGS. 1 and 3.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions, unless a relationship or order is explicitly specified. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive configuration information, wherein the configuration information indicates that a first sounding reference signal (SRS) resource set and a second SRS resource set are configured for a non-codebook based physical uplink shared channel (PUSCH) transmission; and
transmit the PUSCH transmission according to SRS resource(s) in at least one SRS resource set of the first SRS resource set and the second SRS resource set, wherein at least one phase tracking reference signal (PT-RS) of the PUSCH transmission is transmitted with at least one PT-RS port based on the configuration information.

2. The UE of claim 1, wherein in a case that the UE has reported a UE capability of supporting full-coherent uplink transmission, all SRS resources in the first SRS resource set are configured with a first PT-RS port and all SRS resources in the second SRS resource set are configured with a second PT-RS port.

3. The UE of claim 2, wherein in a case that the PUSCH transmission is associated with the second SRS resource set, the at least one processor is further configured to cause the UE to transmit a PT-RS of the PUSCH transmission with the first PT-RS port.

4. The UE of claim 2, wherein in a case that the PUSCH transmission is associated with the second SRS resource set, the at least one processor is further configured to cause the UE to:
transmit a PT-RS of the PUSCH transmission with the second PT-RS port; and
determine a demodulation reference signal (DM-RS) port associated with the second PT-RS port based on a PTRS-DMRS association indicator and a PTRS-DMRS association table for the first PT-RS port.

5. The UE of claim 1, wherein in a case that the UE has reported a UE capability of supporting full-coherent uplink transmission, all SRS resources in the first SRS resource set and all SRS resources in the second SRS resource set are configured with a first PT-RS port.

6. The UE of claim 5, wherein in a case that a first set of layers of the PUSCH transmission is associated with the first SRS resource set and a second set of layers of the PUSCH transmission is associated with the second SRS resource set, the at least one processor is further configured to cause the UE to transmit a first PT-RS associated with the first set of layers of the PUSCH transmission with the first PT-RS port, and transmit a second PT-RS associated with the second set of layers of the PUSCH transmission with the second PT-RS port.

7. The UE of claim 1, wherein in a case that a total number of PT-RS ports configured for all SRS resources in each of the first SRS resource set and the second SRS resource set is 2, wherein the configured PT-RS ports include a first PT-RS port and a second PT-RS port, and a first set of layers of the PUSCH transmission is associated with the first SRS resource set and a second set of layers of the PUSCH transmission is associated with the second SRS resource set, the at least one processor is further configured to cause the UE to:
transmit the first set of layers of the PUSCH transmission according to at least one SRS resource which is configured with the first PT-RS port in the first SRS resource set, wherein a first PT-RS associated with the first set of layers of the PUSCH transmission is transmitted with the first PT-RS port, and transmit the second set of layers of the PUSCH transmission according to at least one SRS resource which is configured with the second PT-RS port in the second SRS resource set, wherein a second PT-RS associated with the second set of layers of the PUSCH transmission is transmitted with the second PT-RS port, or
transmit the first set of layers of the PUSCH transmission according to at least one SRS resource which is configured with the second PT-RS port in the first SRS resource set, wherein the first PT-RS associated with the first set of layers of the PUSCH transmission is transmitted with the second PT-RS port, and transmit the second set of layers of the PUSCH transmission according to at least one SRS resource which is configured with the first PT-RS port in the second SRS resource set, wherein the second PT-RS associated with the second set of layers of the PUSCH transmission is transmitted with the first PT-RS port.

8. A base station (BS) for wireless communication, comprising:
at least one memory; and
at least one processor coupled with the at least one memory and configured to cause the BS to:
transmit configuration information, wherein the configuration information indicates that a first sounding reference signal (SRS) resource set and a second SRS resource set are configured for a non-codebook based physical uplink shared channel (PUSCH) transmission; and
receive the PUSCH transmission according to SRS resource(s) in at least one SRS resource set of the first SRS resource set and the second SRS resource set, wherein at least one phase tracking reference signal (PT-RS) of the PUSCH transmission is received with at least one PT-RS port based on the configuration information.

9. The BS of claim 8, wherein all SRS resources in the first SRS resource set are configured with a first PT-RS port and all SRS resources in the second SRS resource set are configured with a second PT-RS port.

10. The BS of claim 9, wherein in a case that the PUSCH transmission is associated with the second SRS resource set, the at least one processor is further configured to cause the BS to receive a PT-RS of the PUSCH transmission with the first PT-RS port.

11. (canceled)

12. The BS of claim 8, wherein all SRS resources in the first SRS resource set and all SRS resources in the second SRS resource set are configured with a first PT-RS port.

13. (canceled)

14. (canceled)

15. A method performed by a user equipment (UE), the method comprising:
receiving configuration information, wherein the configuration information indicates that a first sounding reference signal (SRS) resource set and a second SRS resource set are configured for a non-codebook based physical uplink shared channel (PUSCH) transmission; and
transmitting the PUSCH transmission according to SRS resource(s) in at least one SRS resource set of the first SRS resource set and the second SRS resource set, wherein at least one phase tracking reference signal (PT-RS) of the PUSCH transmission is transmitted with at least one PT-RS port based on the configuration information.

16. The method of claim 15, wherein in a case that the UE has reported a UE capability of supporting full-coherent uplink transmission, all SRS resources in the first SRS resource set are configured with a first PT-RS port and all SRS resources in the second SRS resource set are configured with a second PT-RS port.

17. The method of claim 15, wherein in a case that the UE has reported a UE capability of supporting full-coherent uplink transmission, all SRS resources in the first SRS resource set and all SRS resources in the second SRS resource set are configured with a first PT-RS port.

18. A processor for wireless communication, comprising:
at least one controller coupled with at least one memory and configured to cause the processor to:
receive configuration information, wherein the configuration information indicates that a first sounding reference signal (SRS) resource set and a second SRS resource set are configured for a non-codebook based physical uplink shared channel (PUSCH) transmission; and
transmit the PUSCH transmission according to SRS resource(s) in at least one SRS resource set of the first SRS resource set and the second SRS resource set, wherein at least one phase tracking reference signal (PT-RS) of the PUSCH transmission is transmitted with at least one PT-RS port based on the configuration information.

19. The processor of claim 18, wherein in a case that the processor has reported a UE capability of supporting full-coherent uplink transmission, all SRS resources in the first SRS resource set are configured with a first PT-RS port and all SRS resources in the second SRS resource set are configured with a second PT-RS port.

20. The processor of claim 19, wherein in a case that the PUSCH transmission is associated with the second SRS resource set, the at least one controller is further configured to cause the processor to transmit a PT-RS of the PUSCH transmission with the first PT-RS port.

21. The processor of claim 19, wherein in a case that the PUSCH transmission is associated with the second SRS resource set, the at least one controller is further configured to cause the processor to:
transmit a PT-RS of the PUSCH transmission with the second PT-RS port; and
determine a demodulation reference signal (DM-RS) port associated with the second PT-RS port based on a PTRS-DMRS association indicator and a PTRS-DMRS association table for the first PT-RS port.

22. The processor of claim 18, wherein in a case that the processor has reported a UE capability of supporting full-coherent uplink transmission, all SRS resources in the first SRS resource set and all SRS resources in the second SRS resource set are configured with a first PT-RS port.

23. The processor of claim 22, wherein in a case that a first set of layers of the PUSCH transmission is associated with the first SRS resource set and a second set of layers of the PUSCH transmission is associated with the second SRS resource set, the at least one processor is further configured to cause the UE to transmit a first PT-RS associated with the first set of layers of the PUSCH transmission with the first PT-RS port, and transmit a second PT-RS associated with the second set of layers of the PUSCH transmission with the second PT-RS port.
